(19) United States
(12) Patent Application Publication
(10) Pub. No.: US 2013/0297508 A1
(43) Pub. Date: Nov. 7, 2013

(54) SECURE FINANCIAL TRANSACTIONS

(71) Applicant: NET 1 UEPS Technologies Inc., (US)

(72) Inventor: Serge Christian Pierre Belamant, Sandton (ZA)

(21) Appl. No.: 13/774,804

(22) Filed: Feb. 22, 2013

Related U.S. Application Data
(62) Division of application No. 12/515,058, filed on Dec. 15, 2009.

(30) Foreign Application Priority Data
Nov. 16, 2006 (ZA) 2006/09533

(51) Int. Cl. G06Q 20/40

(52) U.S. Cl. CPC G06Q 20/40
USPC 705/44; 705/39

(57) ABSTRACT

A primary account number (“PAN”) of a conventional credit or debit account with a bank or other financial institution is emulated or simulated, which incorporates, in encrypted form, the actual account number. The simulated PAN may also incorporate an amount to be debited from that account. Thus, an account number and an amount are encrypted and mapped into a string of digits which appears to be a valid PAN. The actual account number and the transaction amount are thus embedded in the simulated PAN. The simulated PAN is then processed by existing financial transacting infrastructure, with the issuing bank knowing that it is not a PAN and that the appropriate digits are to be decrypted to provide the embedded account number and the embedded amount.

This invention relates to electronic financial transactions. More particularly it relates to a financial transaction number generator, a carrier for an algorithm for the generator, a memory module for use with the generator, a financial institution processing facility, a method of conducting a financial transaction, a method of processing a financial transaction, and a method of facilitating a financial transaction.

Generally according to the invention a primary account number (“PAN”) of a conventional credit or debit account with a bank or other financial institution is emulated or simulated, which incorporates, in encrypted form, the actual account number. The simulated PAN may also incorporate an amount to be debited from that account. Thus, an account number and an amount are encrypted and mapped into a string of digits which appears to be a valid PAN. The actual account number and the transaction amount are thus embedded in the simulated PAN. The simulated PAN is then processed by existing financial transacting infrastructure, with the issuing bank knowing that it is not a PAN and that the appropriate digits are to be decrypted to provide the embedded account number and the embedded amount. In one application, a transactor wishing to effect a financial transaction, generates a simulated PAN and supplies it to a supplier of goods or services from whom he wishes to purchase said goods or services. The supplier enters the simulated PAN and the amount of the transaction in a conventional way. This data is then transmitted to an acquiring bank, which onwardly transmits it to the issuing bank for authorisation. The issuing bank then extracts the embedded account number and embedded amount, checks that the embedded amount and the supplied amount are the same (as well as other conventional checks), and if they are the same authorizes the transaction. Those skilled in the art will appreciate that, in most instances, a transactor is required to provide an expiry date and a card verification value (“CVV”). Either or both of these could also be simulated and used to encrypt information. Further, those skilled in the art will be aware that a bank identification number (“BIN”) is provided in the first part of a PAN and this will still be the case with the simulated PAN.

It will accordingly be appreciated that the security of Internet and telephone transactions, in particular, will be improved, by means of the invention.

Thus, according to a first aspect of the invention there is provided a financial transaction number generator for generating a unique transaction number, in which the transaction number simulates a conventional credit or debit card primary account number and incorporates therein an account number of a transactor.

The generator may also incorporate in the transaction number a transaction amount.

Further according to this first aspect of the invention there is provided a method of conducting a financial transaction which includes generating a simulated PAN which contains an account number embedded therein, together, possibly, with a transaction amount.

This aspect of the invention extends to supplying such a simulated PAN to a supplier of goods or services and to the receipt of such a simulated PAN by a supplier of goods or services.

The simulated PAN may be in a humanly discernible form. In particular, in order to operate with existing transaction infrastructure it may comprise a string of numeric digits. Those skilled in the art will appreciate that the string may have between 16 and 23 digits.

Those skilled in the art will further appreciate that the first 6 digits of the simulated PAN will designate the BIN, which, as explained above, enables the transaction to be routed to the appropriate issuing financial institution, and to enable the issuing financial institution to recognize that it has received a simulated PAN containing the embedded account number and transaction amount. Similarly, those skilled in the art will appreciate that the last digit of the simulated PAN will be a check digit

The PAN generator may supply a unique sequence of digits which represents the encrypted information, a new sequence being provided each time. The generator may thus utilize a suitable encryption algorithm to provide a unique encrypted sequence each time.

As indicated above, the encrypted sequence may also include a transaction amount.

Further, as indicated above, the CVV and/or the expiry date may also be simulated and incorporate encrypted information.

The generator may incorporate an electronic purse, the transaction amount being debited when the simulated PAN is generated.

The simulated PAN may also have embedded therein in an encrypted form, an indication of the identity of the intended payee. Thus, the generator may prompt a user to enter the name or an account number of the intended payee, which is then also encrypted and embedded in the simulated PAN.

In the event that the simulated PAN is intended for use by an intermediary, it may be provided in an intermediate, encrypted form as an alphanumeric string, which requires a one-time password to decrypt it and provide a usable, simulated PAN. The intermediate form is then supplied to the intermediary by one channel, and the password by a different channel. The generator may then have a facility to provide either the simulated PAN or the intermediate form together with the one-time password. Further, the generator may then also have a facility to receive the intermediate form and the password, decrypt the alphanumeric string, and provide a usable simulated PAN.

Further, a permitted transaction medium may be specified in the simulated PAN. Thus, if the simulated PAN may only be used with a POS device, at an ATM, with a telephonic transaction or with an Internet transaction, or any of these, this may also be embedded in the simulated PAN.

The generator may include an electronic processing device, a memory unit, an input device for inputting a request for a simulated PAN and the transaction amount, and a display for displaying the simulated PAN. It will be appreciated that the relevant account number and the encryption algorithm will be stored in the memory unit. The generator may be a mobile device, in particular, a mobile phone handset, in which case the memory unit may be a subscriber identification module (SIM). It will be appreciated that, in the event that a user wishes to include an indication of the intended payee; and/or requires an intermediate form alphanumeric string and associated password; and/or wishes to specify a particular transaction medium, this may be effected via the input device and display, with suitable prompts and/or menus being provided.

Accordingly the invention extends to a memory module such as a SIM which has stored thereon an appropriate BIN; an account number; an encryption algorithm for encrypting the account number and a supplied transaction amount to supply a simulated PAN which incorporates the BIN and an encrypted sequence of digits in which the account number and transaction amount are embedded.

The invention also extends to a carrier for providing the generator with the encryption algorithm, which has the encryption algorithm therein or thereon, preferably together with the account number.

The invention further extends to a method of facilitating a financial transaction in which an encrypted financial transaction number that simulates a conventional credit or debit card primary account number and which has incorporated therein an account number of a transactor is generated by a transactor, which includes providing the transactor with a memory module which has the transactor's account number and an encryption algorithm stored therein.

Similarly, the invention further extends to a method of facilitating a financial transaction in which an encrypted financial transaction number that simulates a conventional credit or debit card primary account number and which has incorporated therein an account number of a transactor is generated by a transactor, which includes transmitting to the transactor his account number and an encryption algorithm.

Further, according to a second aspect of the invention, there is provided a financial institution processing facility for processing a financial transaction number that simulates a conventional credit or debit card primary account number and which has incorporated therein an account number of a transactor, which includes

an extractor for extracting from the simulated primary account number the account number.

This aspect extends to a system for processing financial transactions which includes a financial institution processing facility as described above, together with a financial transaction number generator, also as described above.

Still further according to this aspect of the invention, there is provided a method of processing a financial transaction, which includes

receiving an ostensible financial transaction number that simulates a conventional credit or debit card primary account number and which has incorporated therein an account number of a transactor together with a request to authorize payment of a deal amount; and

extracting from the simulated primary account number the account number.

The simulated PAN may be received via a conventional financial communication network.

As indicated above, the PAN will have a BIN incorporated therein, the remaining digits of the simulated PAN being decrypted. Thus, the system may have a separating means for separating the encrypted digits from the BIN. Further, if the transaction amount has also been encrypted, the decrypting means also decrypts the transaction amount.

If, as discussed above, the CVV and/or the expiry date have also been simulated and contain encrypted information, they are also decrypted.

If the simulated PAN has the transaction amount embedded therein, the embedded amount is decrypted and compared with the deal amount supplied in conventional manner, by a comparison means. If they are different the transaction is refused.

Similarly, if the simulated PAN incorporates an indication of the intended payee, then this is also extracted and may be compared with payee details supplied with the simulated PAN in conventional manner; and if the simulated PAN also incorporates a specified transaction medium, this is also extracted and a check may be performed to see if the transaction medium used was correct.

The system may include a storage means for storing the simulated PAN's that have been received, or at least the encrypted component thereof, and a comparison means for comparing a received simulated PAN (or the encrypted component thereof) with stored simulated PAN's (or the stored encrypted component thereof) to ensure that a simulated PAN may only be used once.

If a transaction is approved, an authorization is supplied to an acquiring bank or a supplier of goods or services and the appropriate account of the transactor is debited with the transaction amount.

The invention will now be described by way of non-limiting examples, with reference to the accompanying diagrammatic drawing, in which:—

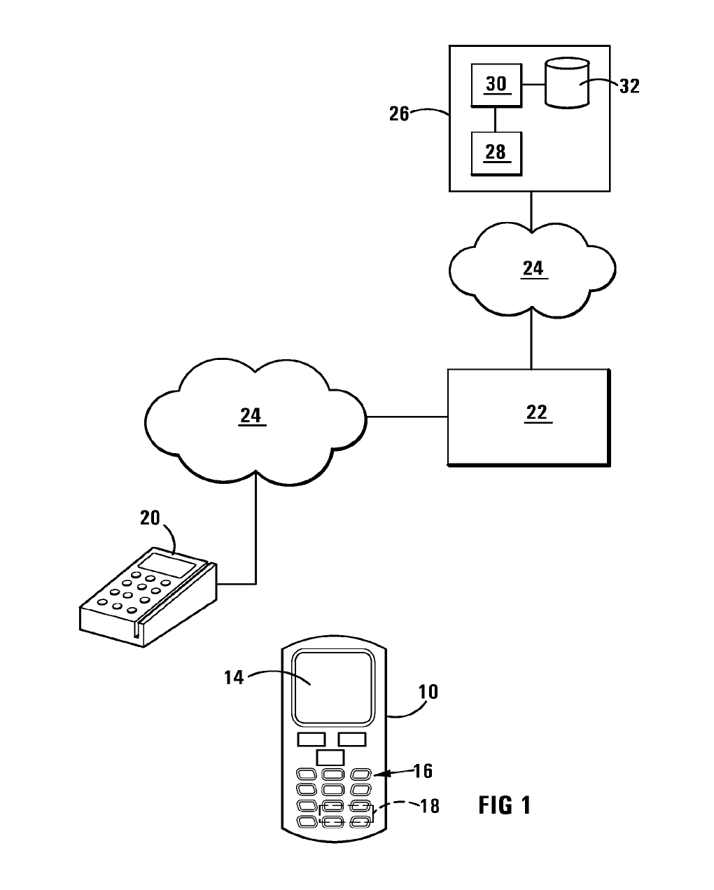

FIG. 1 shows a first implementation of the invention;

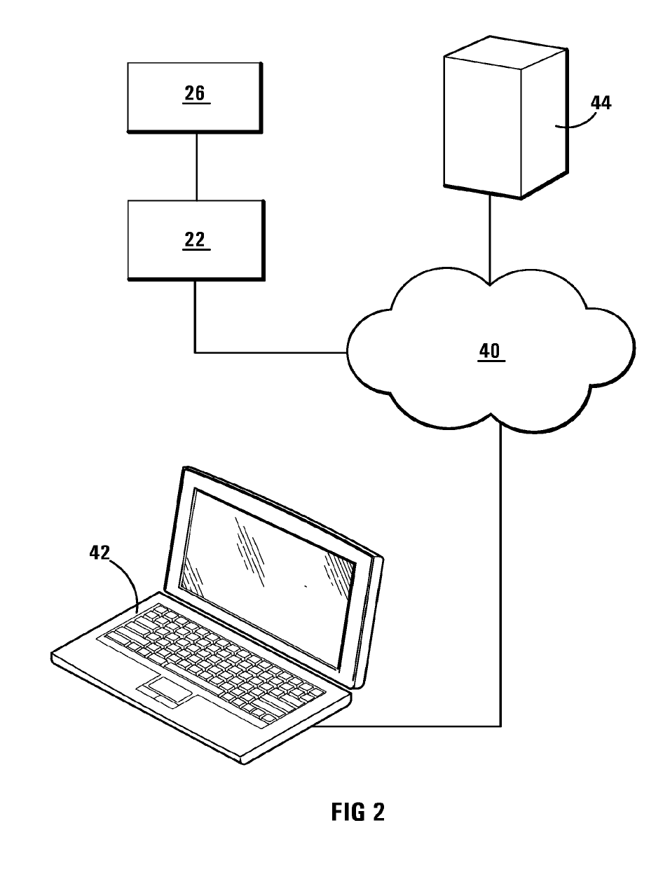

FIG. 2 shows a second implementation of the invention; and

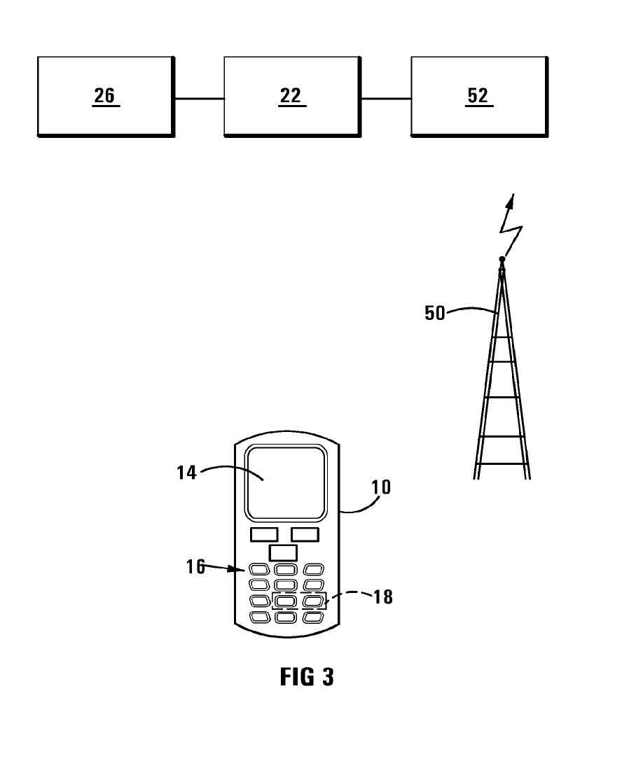

FIG. 3 shows a third implementation of the invention.

Referring to FIG. 1, a first implementation of the invention is shown. A transactor wishing to purchase goods from a merchant has an generator in the form of a mobile telephone 10. The telephone 10 has a display 14, a key pad 16 and a SIM card 18. An application has been loaded onto the SIM card 18 to provide a simulated PAN as discussed above. Thus, the SIM card 18 has stored thereon the transactor's account number, a BIN, an encryption algorithm and a PIN. The transactor enters, via the key pad 16, a request to activate the application, together with his PIN, and then enters the transaction amount, using the key pad 16, when prompted to do so via the display. The application then generates the simulated PAN, a CVV and an expiry date which are displayed on the display 14. It will be appreciated that the telephone 10 and SIM card 18 provide a virtual credit or debit card.

The transactor reads out the PAN, the CVV and the expiry date to a check-out person who manually enters the relevant digits into a point of sale (POS) device 20 together with the deal amount. The simulated PAN is checked by the POS device 20 to ensure that the check digit thereof is correct and the simulated PAN, CVV and expiry date, and the deal amount, are transmitted, in conventional manner to the merchant's acquiring bank 22, via a conventional financial network 24. The acquiring bank 22 identifies the appropriate issuing bank 26 from the BIN and forwards the simulated PAN, the CVV and expiry date, and the deal amount, to the issuing bank 26. The issuing bank 26 has a communication interface 28, a processor 30 and a storage unit 32. The simulated PAN, CVV and expiry date, and the transaction amount, are supplied to the processor 30 which separates the encrypted part from the simulated PAN, CVV and expiry date. This is then compared with a list of all previously received numeric strings that have been stored in the storage unit 32. If the string is unique and has not previously been used, it is added to the stored list. If it has previously been used and is stored on the list then the transaction is refused and an appropriate message is sent to the acquiring bank 22 and then to the merchant. If the string has not previously been used, it is decrypted by the processor 30 using an appropriate decryption algorithm to extract the transactor's account number and the embedded transaction amount. A PIN or other identifier is not required by the issuing bank. The embedded transaction amount is compared with the supplied deal amount, and if they differ the transaction is refused. The processor 30 checks if the transactor has sufficient funds and if so the transactor's account is debited and a conventional authorisation is supplied to the acquiring bank 22 which credits the merchant's account and informs the merchant that the transaction has been effected.

The SIM card 18 may operate as an electronic purse, in which case the purse is debited with the transaction amount when the simulated PAN, CVV and expiry date are supplied.

Referring to FIG. 2, a second implementation of the invention is shown, in which a financial transaction is effected via the Internet 40. In this implementation the generator 42 is a laptop computer which has the application loaded thereon to provide a simulated PAN as discussed above. The computer 42 also has stored thereon the transactor's account number, the BIN, the encryption algorithm and the PIN.

When the transactor wishes to purchase goods or services, or obtain pre-authorization, from a supplier, via the Internet, he generates a simulated PAN, CVV and expiry date, which are supplied, via the Internet 40, to a server 44 operated by the supplier. This is then transmitted to the supplier's acquiring bank 22, which forwards it to the issuing bank 26. The matter is then securely processed as described above with reference to FIG. 1.

In a similar manner, a secure transaction may be conducted telephonically, as shown in FIG. 3. In this implementation, the generator is again a mobile telephone 10 such as that of FIG. 1. Thus, the transactor supplies the simulated PAN, CVV and expiry date as supplied by the telephone 10, via a telephone network 50 to an operator at a call centre 52. This is then forwarded, together with the transaction amount, in conventional manner, to the acquiring bank 22 and the issuing bank 26. The issuing bank processes the transaction as described above with reference to FIG. 1.

An example of how the simulated PAN is generated and processed is now described.

| BIN | PAN | CD | CVV | EXP DATE |
|---|---|---|---|---|
| 6 | 9 | 1 | 3 | 4 |
| XXXXXX | \|.........\| | X | (...) | MM/YY |

1. Client USN=3 bytes
1st byte=F1, can be determined by the BIN
Let USN=9876 5432 (max 8 digits)

### 2. Create the Expiry Date

Use 5 years as the expiry date of the card—this is 60 months, less 12 months (to cater for the current year less 1).
This leaves us with 48 months.
EXPDATE=TRXTYPE[2 bits].AID[4 bits]

WHERE:
AID [2 bits]=00, 01, 10, 11
TRX TYPE [4 bits]=0000, 0001, 0010, 0011, 0100, 0101, 0110, 0111, 1000, 1001, 1010, 1011
MONTH=TRX TYPE +1 (+1 so that we don't end up with month=0)
MM=Binary_To_ASCII(MONTH)
YEAR=(current year +1) +AID (CCYY)
YY=Binary_To_ASCII (last 2 digits of the YEAR)

### NOTE:

MM and YY are displayable (ASCII) digits. These 4 digits are typed in as the required expiry date into a terminal
MONTH[1]=binary equivalent of MM (Result is always 1 byte)
YEAR[2]=binary equivalent of YEAR including the century (Result is always 2 bytes)
AID is the account/wallet which is being Debited or Credited.
   3. Create the Expiry Date Mapping Values (EDMV) (Here, We have Space for More Stuff)
This step introduces some randomness into the month and year that was created, as well as a verification method that it was entered correctly on the terminal.

EDMV=1DES((YEAR[2]+00.MONTH[1])[2].YEAR[2].MONTH[1].(YEAR[2]-00.MONTH[1])[2].FF)

### NOTE:

A Static Key is used to create the encrypted block (EDMV Key)
(YEAR[2]+00.MONTH[1]) result is always a 2 byte value
(YEAR[2]-00.MONTH[1]) result is always a 2 byte value
EDMV1[2]=last 2 bytes of the EDMV result
EDMV2[2]=second 2 bytes of the EDMV result
If MM/YY was entered in incorrectly on the terminal then the EDMV will be different and therefore the encryption block will not be created correctly and the CVV match will fail

### 4. Create a CheckSum for the USN—(Diversified Key)

CVV=3DES(USN[3].ULSN[2].ULP[1].EDMV1[2])

### NOTE:

Use Triple DES, Triple Key, diversified under USN
Diversified Keys (USN based) are used to create the encrypted block (Host Keys)
Convert CVV to displayable (ASCII) numbers
CVV_{—}1=Last 3 digits of the displayable (ASCII) result.

This 3 digit value is typed in as the required CVV into a terminal (Final CVV)
CVV_{—}2=Binary equivalent of CVV_{—}1 (always 2 bytes)

### 5. Create PIN Encrypted Checksum for USN

If the users enters a PIN, the PIN will form part of the encrypting key.
If the user does not enter in a PIN, a default PIN key will be used.

CVV_PIN=1DES(CVV[8])

### NOTE:

If a PIN is NOT required, then a static key (PIN_KEY) is used to create the encrypted block
If a PIN is required, then the PIN is generated by the User and can be between 4-8 digits (inclusive).

Each digit represents a hex equivalent nibble that will replace the PIN_KEY from Least Significant Nibble

to Most Significant Nibble
Convert CVV_PIN to displayable (ASCII) digits
CVV_PIN1=Last 3 digits of the displayable (ASCII) result. This 3 digit value is typed in as the required CVV into the terminal
   The CVV is changed due to the PIN and thus the HOST will re-create an incorrect CVV and the CVV match will fail

### 6. Create Unload Signature

AMT[2]=last 2 bytes of the 4 byte Amount
CVV_PIN2[2]=binary equivalent of CVV_PIN1 (Result is always 2 bytes)

CVV_TEMP=(AMT[2]XOR CVV_PIN2[2])
SIGN=3DES(AMT[4].CVV_TEMP[2].EDMV2[2])
SIGN=9999 9999 99

### NOTE:

Static Keys are used to create Unload Signature
Unload Signature usually contains an Unload LSN, but the CVV_TEMP already has that included.
   7. SIGN=First 8 digits.
PAN=USN+SIGN (result is max 9 digits). Optional−[(USN*YY+YY*MM)+SIGN]
PAN=9876 5432 (USN)+9999 9999 (SIGN)
PAN=1987 6543 1

### Calculate the Checksum for the PAN

Place PAN into PAN buffer
At this point, the complete PAN, Expiry Date and CVV is created.

### 8. On Host:

1. Recreate the Expiry Date Mapping Values (EDMV1 and EDMV2) (Step 3)
   The TRXTYPE and the AID can be determined from the MM and YY
   TRXTYPE[2 bits].AID[3 bits]=((YY−(current year +1))*12)+MM
2. Recreate the Unload Signatre (SIGN), using the CVV received from terminal (Step 4,5)
3. USN=PAN-SIGN
4. Now the Host can get the HOST KEY, ULSN and ULP
5. Recreate CVV using the calculated USN
6. Compare recreated CVV (Step 4) to CVV received from the terminal

### Verifications

1. 3 digit CVV match
2. CVV is not recreated if SIGN is wrong.
3. CVV is not recreated if USN is wrong.
4. CVV is not matched correctly if the the EDMV is wrong

### Summary on Card

1. Use the USN, ULSN, ULP to create a CVV
2. Use the CVV to create the SIGN
3. Now, PAN=USN+SIGN

### Summary on Host

1. Use the CVV received to create the SIGN
2. Use the SIGN to get the USN by using the PAN (USN=PAN-SIGN)
3. Use the USN to get the HOST KEY, ULSN, ULP to create the CVV
4. Compare the CVV created to the CVV received from the terminal

Those skilled in the art will appreciate that it will be extremely difficult, if not impossible, for a fraudulent transaction to be performed if the transaction is conducted in accordance with the invention.

1-17. (canceled)

18. A financial institution processing facility for processing a financial transaction number that simulates a conventional credit or debit card primary account number and which has incorporated therein an account number of a transactor, which includes an extractor for extracting from the simulated primary account number the account number.

19. The financial institution processing facility as claimed in claim 18, in which the financial transaction number also incorporates a transaction amount and the financial transaction number is received together with a request to authorize payment of a deal amount, and in which the extractor also extracts from the simulated primary account number the transaction amount.

20. The financial institution processing facility as claimed in claim 18, which includes a single use checking arrangement for ensuring that a received simulated primary account number may only be used once.

21. The financial institution processing facility as claimed in claim 20, in which the single use checking arrangement includes a store in which at least designated portions of previously received simulated primary account numbers are stored and a comparator for comparing at least the designated portion of a received simulated primary account number with the stored portions.

22. The financial institution processing facility as claimed in claim 19, which includes a response message generator for generating a message to a transactee to approve or refuse the requested transaction.

23. The financial institution processing facility as claimed in claim 22, which includes a forwarding arrangement for forwarding the response message to the transactee via a conventional financial communication network.

24. The financial institution processing facility as claimed in claim 18, which includes a receiving arrangement for receiving the simulated primary account number via a conventional financial communication network.

25. The financial institution processing facility as claimed in claim 22, which includes a transaction checking arrangement for checking if the transactor has an account, if he has sufficient funds, and if the extracted transaction amount is the same as the deal amount and for authorizing the transaction if these are all correct, the response message generator being responsive thereto.

26. The financial institution processing facility as claimed in claim 25, which includes a debiting arrangement for debiting the transactor's account with the deal amount if the transaction is authorized.

27. The financial institution processing facility as claimed in claim 18, which includes a decryptor for decrypting encrypted simulated primary account numbers.

28. The financial institution processing facility as claimed in claim 18, in which the financial transaction number has been generated by the transactor.

29-43. (canceled)

44. A method of processing a financial transaction, which includes receiving an ostensible financial transaction number that simulates a conventional credit or debit card primary account number and which has incorporated therein an account number of a transactor, together with a request to authorize payment of a deal amount; and extracting from the simulated primary account number the account number.

45. The method of processing a financial transaction as claimed in claim 44, in which the received financial transaction number also has incorporated therein a transaction amount and which includes also extracting the transaction amount.

46. The method of processing a financial transaction as claimed in claim 44, which includes ensuring that a received simulated primary account number may only be used once.

47. The method of processing a financial transaction as claimed in claim 46, which includes storing at least designated portions of previously received simulated primary account numbers and comparing at least the designated portion of a received simulated primary account number with the stored portions.

48. The method of processing a financial transaction as claimed in claim 44, which includes generating a response message to a transactee to approve or refuse the requested transaction.

49. The method of processing a financial transaction as claimed in claim 48, which includes forwarding the response message to the transactee via a conventional financial communication network.

50. The method of processing a financial transaction as claimed in claim 44, which includes receiving the simulated primary account number via a conventional financial communication network.

51. The method of processing a financial transaction as claimed in claim 45, which includes checking if the transactor has an account, if he has sufficient funds, and if the extracted transaction amount is the same as the deal amount, and authorizing the transaction if these are all correct.

52. The method of processing a financial transaction as claimed in claim 51, which includes debiting the transactor's account with the deal amount if the transaction is authorized.

53. The method of processing a financial transaction as claimed in claim 44, which includes decrypting encrypted simulated primary account numbers.

54. The method of processing a financial transaction as claimed in claim 44, in which the financial transaction number was generated by the transactor.

55. A method of facilitating a financial transaction in which an encrypted financial transaction number that simulates a conventional credit or debit card primary account number and which has incorporated therein an account number of a transactor is generated by a transactor, which includes providing the transactor with a memory module which has the transactor's account number and an encryption algorithm stored therein.

56-60. (canceled)
